(19) United States
(12) Patent Application Publication
(10) Pub. No.: US 2020/0338761 A1
(43) Pub. Date: Oct. 29, 2020

(54) SAFETY PROTECTION OF A ROBOT JOINT

(71) Applicant: SOFTBANK ROBOTICS EUROPE, Paris (FR)

(72) Inventors: Fabien MUGNIER, PARIS (FR); Vincent CLERC, CLAMART (FR); Robert HONG, PARIS (FR)

(21) Appl. No.: 16/958,690

(22) PCT Filed: Dec. 27, 2018
(86) PCT No.: PCT/EP2018/097052

§ 371 Date: Jun. 27, 2020

(30) Foreign Application Priority Data
Dec. 27, 2017 (FR) 1763287

(51) Int. Cl. B25J 19/00; B25J 17/02

(52) U.S. Cl. CPC B25J 19/0083; B25J 17/0258

(57) ABSTRACT

The operating safety of a robot is provided. The robot includes two elements that can move relative to one another, a joint with at least one degree of freedom, connecting the two elements; and a flexible elastic film surrounding the joint and attached to each of the two elements, the film being stretched between its attachments in at least one configuration of the two elements.

The invention relates to the safety of use of a robot. Robots are intended to interact with humans and more generally with their environment. Not only is it necessary to protect the environment of the robot with regard to actions carried out thereby but it is also necessary for the robot to be protected from its environment.

As regards the protection of the environment of the robot, it is necessary to prevent movements of the robots from being able to injure humans or damage objects surrounding them. More specifically, when certain joints of the robot move, humans or objects located in the vicinity could be pinched thereby. For example, in a humanoid robot, when the robot's torso moves toward its pelvis, there is a risk of trapping between the pelvis and the torso. More generally, the risk of trapping exists between two elements of the robot that are articulated with respect to one another.

Several solutions have been conceived of to reduce the risk of trapping or to limit the consequences thereof. To avoid any trapping, it is possible to limit the displacement of a joint by means of a stop that makes it possible to maintain a sufficient spacing between the elements connected by the joint in question. This solution limits the capabilities of the robot by preventing it from moving in certain ways. In the case of a humanoid robot, the anthropomorphism thereof is then impaired.

If there is no desire to reduce the risk of trapping, it is still possible to reduce the consequences thereof. To this end, it is possible to reduce the force produced by the actuator moving the joint in question. This reduction in force also limits the capabilities of the robot, which, for example, may no longer be able to lift heavy loads. It is possible to limit the force of an actuator only at the end of travel, when the two elements approach one another. This limiting requires complex control of the actuator. This control is expensive to implement and may bring about a reduction in reliability of the robot.

Moreover, if the power supply of the robot is lost, the actuator may lose its restraining capacity and the joint may become entirely free. The elements of the robot that are linked by this joint are then driven under the effect of gravity, and this can result in uncontrolled movements of the joint. Trapping may occur during these movements.

Furthermore, the robot may contain heat sources that can have a detrimental effect on the environment of the robot. For example, the robot may comprise motors or electronic equipment liable to heat up while they are operating. A user could burn themselves if they can access the heat sources without protection. To avoid this risk, the robot may comprise rigid shells possibly provided with heat shields that prevent the user from accessing the heat sources. However, it is necessary to evacuate the heat emitted by the robot and the presence of shells makes it more difficult to cool the heat sources. Moreover, for the joints, the presence of shells can hamper the movements of the articulated elements or at least reduce the displacement thereof.

As regards the protection of components of the robot with respect to the environment thereof, the robot more particularly has to be protected from the intentional or unintentional insertion of objects liable to damage it. To this end, the rigid shells can form a suitable preventative solution, but with the drawbacks mentioned above.

The invention aims to improve the safety of operation of a robot by means of an entirely passive solution that makes it possible to limit the risk of trapping and/or penetration of objects in a joint. The invention also aims to reduce the risk of contact with internal heat sources of the robot while allowing it to be cooled. The invention avoids the use of rigid shells surrounding a joint.

To this end, the subject of the invention is a robot comprising:
two elements that are movable with respect to one another,
a joint having at least one degree of freedom connecting the two elements,
a flexible and elastic film that surrounds the joint and is fixed to each of the two elements, the film being stretched between a first fixing point on the first element and a second fixing point on the second element in at least one configuration of the two elements, the tension in the film varying depending on a variation in a distance between the two fixing points during movements of the joint about the configuration.

The presence of a film makes it possible to isolate the joint from the outside. It is thus possible to design it more simply. Specifically, the elasticity of the film makes it possible to avoid complex strings of dimensions required by rigid mechanical parts that protect the joint. The employment of a film makes it possible in particular to avoid the presence of functional clearances between the various moving parts surrounding the joint. The employment of a film also makes it possible to reduce the weight of the robot compared with the employment of rigid shells that are often much heavier.

The tension in the film is advantageously substantially proportional to the variation in distance between the two fixing points.

Advantageously, the robot comprises a collar that surrounds the first of the two elements and is connected to the first element by way of a free pivot link, wherein the film is fixed to the first element by way of the collar.

The joint is rotatable about a first axis, and advantageously, an axis of rotation of the pivot link connecting the collar to the first element is coincident with the first axis.

Advantageously, a range of angular displacement of the joint about the first axis is greater than a range of angular displacement of the pivot link about the first axis.

The joint may be rotatable about a first axis and about a second axis perpendicular to the first axis, an angular displacement of the joint about the first axis being greater than an angular displacement of the joint about the second axis. An angular sector about the first axis that is taken up by the film between its fixing points is advantageously greater than an angular sector about the second axis that is taken up by the film between its fixing points.

The film is advantageously a fabric, which may comprise a fiber based on a polyether-polyurea copolymer.

The fabric is advantageously breathable.

The film advantageously comprises an electrically insulating material and/or an electrically conducting material.

The robot may be a humanoid robot and comprise a torso and a pelvis, the joint connecting the torso and the pelvis.

The invention will be understood better and further advantages will become apparent from reading the detailed description of an embodiment given by way of example, the description being illustrated by the appended drawing, in which:

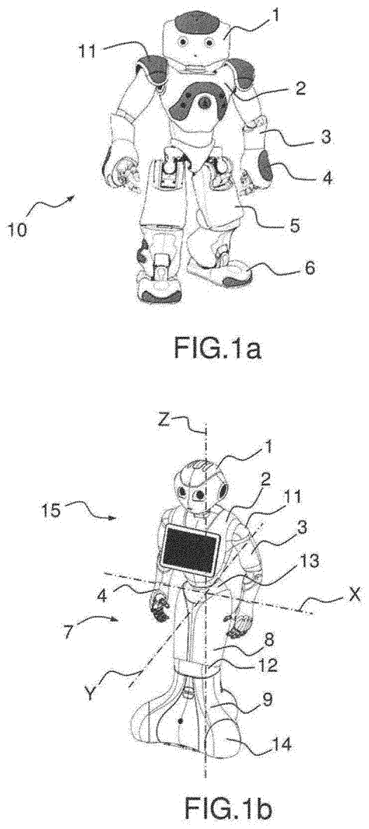

FIGS. 1a and 1b show two examples of robots in which the invention can be implemented;

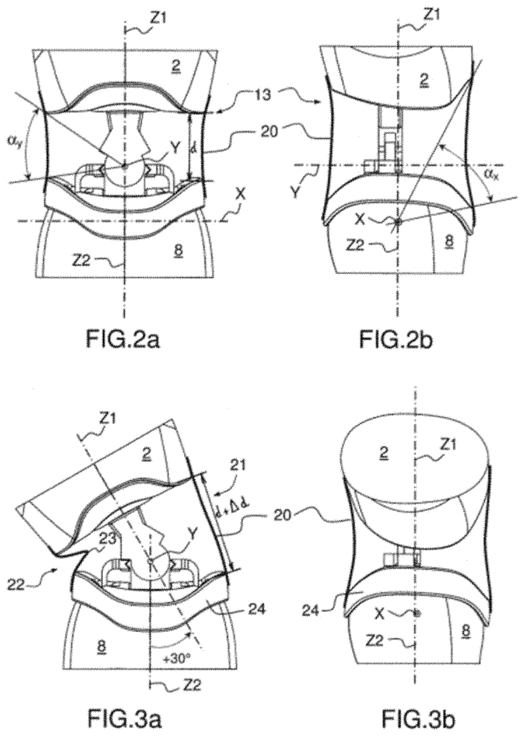

FIGS. 2a and 2b show the torso and the pelvis of the robot in FIG. 1b in a vertical configuration;

FIGS. 3a, 3b, 4a, 4b, 5a, 5b, 6a, 6b, 7a and 7b show the torso and the pelvis in several configurations in which the torso is tilted;

FIGS. 2a, 3a, 4a, 5a, 6a and 7a are front views and FIGS. 2b, 3b, 4b, 5b, 6b and 7b profile views.

For the sake of clarity, the same elements will bear the same references in the various figures.

The detailed description of the invention is given in relation to humanoid robots. Of course, the invention can be implemented for other types of robots, for example industrial robots. The invention becomes useful when a joint connects two elements of the robot that are able to move with respect to one another.

A robot can be referred to as humanoid as soon as it has certain human appearance attributes and functionalities, for example a head, a torso, two arms, two hands, two legs or two feet. Some robots that only have the top of the body can also be considered to have humanoid characteristics. Humanoid robots are capable of walking or moving on a platform provided with wheels, and of making gestures, with the limbs or with the head. The complexity of the gestures that they are capable of making is constantly increasing. The interaction of the robots with their environment requires safeguarding of the gestures made. Safeguarding is necessary in order to protect the robot itself and to protect people who approach the robot.

FIGS. 1a and 1b show two examples of humanoid robots developed by the applicant company: Softbank Robotics Europe. The humanoid robot 10 shown in FIG. 1a comprises a head 1, a torso 2, two arms 3, two hands 4, two legs 5 and two feet 6. The humanoid robot 15 shown in FIG. 1b comprises a head 1, a torso 2, two arms 3, two hands 4 and a skirt 7. These two robots comprise a plurality of joints allowing the relative movement of the different limbs of the robot in order to reproduce human morphology and the movements thereof. The different joints can be motorized. The robots 10 and 15 comprise for example a joint 11 between the torso 2 and each of the arms 3. The joint 11 forming a shoulder of the robot is motorized about two axes of rotation to make it possible to move the arm 3 with respect to the torso 2 in the manner of the possible movements of a human shoulder.

The humanoid robot 10 also comprises a plurality of joints for moving the legs of the robot and reproducing walking movement, in particular joints similar to a hip, between the torso and each of the thighs, to a knee, between a thigh and the shank, and to an ankle between the shank and the foot. Several forms of motorized joints are employed, which drive one of the limbs in movement with one or more degrees of rotational freedom.

The humanoid robot 15 has a different architecture. In order to improve stability and lower the center of gravity of the robot, the robot does not have legs but rather a skirt 7 comprising, at its base, a tripod 14 that is capable of moving the robot. The skirt 7 also comprises a first joint 12 resembling a knee, between a pelvis 8 and a leg 9. A second joint 13 resembling a hip connects the torso 2 and the pelvis 8. The joint 13 has at least one degree of rotational freedom in particular about an axis X making it possible to tilt the torso 2 of the robot 15 toward the front or toward the rear. The axis X is a horizontal axis situated in a frontal plane of the robot 15. The joint 13 can also make it possible to tilt the torso 2 to the side, allowing the torso 2 to pivot about a horizontal axis Y situated in a sagittal plane of the robot 15. There can also be a third degree of freedom about a vertical axis Z.

An example of implementation of the invention is described by means of the joint 13 connecting the torso 2 and the pelvis 8 of the robot 15. The motorization of the joint 13 can be ensured by as many motors as there are degrees of freedom of the joint 13. The motor(s) can be situated in the joint 13 itself or away therefrom in the torso 2 or in the pelvis 8. Further joints of the robots 10 and 15 can also be implemented by the invention.

FIGS. 2a and 2b show the torso 2 and the pelvis 8 of the robot 15 in a vertical configuration. It is possible to define an axis Z1 of the torso 2 and an axis Z2 of the pelvis 8. The exterior forms of the robot 15 are substantially mutually symmetric with respect to a sagittal plane of the robot when the latter is in a vertical configuration. In this configuration, the two axes Z1 and Z2 are in the sagittal plane. Moreover, the two axes Z1 and Z2 are aligned and the torso 2 of the robot 15 does not lean toward the front or the rear. The axes Z1 and Z2 are coincident with the axis Z defined above.

The robot 15 comprises a flexible and elastic film 20 that surrounds the joint 13 and is fixed to each of the two elements: the torso 2 and the pelvis 8. On each of the elements, 2 and 8 in the example shown, fixing is realized on a line surrounding the element in question. Fixing to one of the elements can be effected continuously along the line or discontinuously, that is to say at several distinct points on the line surrounding the element in question. The fixing points are advantageously distributed uniformly along the line. Continuous fixing can be realized in a permanent manner or in a removable manner allowing maintenance of the robot, in particular cleaning thereof or access to the joint for potentially changing components. Permanent fixing can be realized in a continuous manner for example by adhesive bonding or thermowelding of the film 20 to the element or in a discontinuous manner for example by means of rivets or staples. Removable fixing can also be realized in a continuous manner for example by means of a zipper, by means of textile hook and loop fasteners commonly known as “Velcro”, by pinching between mechanical parts, for example clip-fastened along a line surrounding the element. Removable fixing can also be realized in a discontinuous manner for example by means of screws, clips, buttons distributed regularly along a line surrounding the element in question. The number of fixing points may be defined depending on the mechanical strength of the film 20 in order to avoid it tearing under the effect of the tension concentrating at each fixing point. Any other permanent or removable fixing means can be employed within the scope of the invention.

In the vertical configuration shown in FIGS. 2a and 2b, the film 20 is stretched between its fixing points. More specifically, by choosing two fixing points 16 and 17 for the film 20, the point 16 being on the torso 2 and the point 17 being on the pelvis 8, around the configuration shown in FIGS. 2a and 2b, the tension in the film 20 varying depending on a variation in distance d between the two fixing points 16 and 17 during movements of the joint 13. More specifically, at least when the distance d increases, the tension in the film 20, that is to say the force exerted by the film 20 on each of the two points 16 and 17, increases initially in proportion to the elongation of the film 20 between the two points 16 and 17. The proportionality coefficient may, initially, be considered to be a Young's modulus of the material of the film 20. In other words, the tension in the film 20 is substantially in proportion to the variation in distance d. In practice, the film 20 passes around the joint 13, and so the film 20 is mainly subjected to tensile stresses oriented in a direction between the two points 16 and 17. The film 20 is subjected less to tensile stresses oriented perpendicularly to the main stresses, and this can slightly alter the proportionality of the tension in the film 20 with respect to the variation in distance d.

In the vertical configuration shown in FIGS. 2a and 2b, the tension in the film 20 is balanced around the joint 13. The film 20 forms a skin surrounding the joint 13. On account of the elasticity of the film 20, when a body foreign to the robot 15 attempts to pass between the torso 2 and the pelvis 8 at the joint 13, the film 20 opposes this penetration. The foreign body can be a user's hand. The film 20 thus protects the user. Similarly, the foreign body can form an object that is dangerous to the joint 13. The film 20 slows access of the foreign body to the joint 13, which is then protected.

FIGS. 3a and 3b show the torso 2 and the pelvis 8 of the robot 15 in a configuration in which the torso 2 of the robot pivots 30° to the right. By convention, the rotation takes place through +30° about the axis Y. In this configuration, the film 20 stretches on one side 21 of the joint 13 and relaxes on the other side 22. In FIG. 3a, the stretched side 21 is to the right and the relaxed side 22 to the left. The distance d visible in FIG. 2a undergoes an increase of Δd during the rotation through +30°. The mechanical characteristics of the film 20 are defined as a function of ranges of angular displacement about the axes X and Y and the distance of the film from the two axes X and Y. On the stretched side 21, the film 20 has to take elongation in its elastic domain at the end of the range of displacement. By contrast, on the relaxed side 22, it is necessary to accept that the film 20 is completely relaxed and even forms a fold 23. More specifically, in the vertical configuration shown in FIGS. 2a and 2b, the film 20 can be preloaded, that is to say under tension on either side of the joint 13. In other words, before being fitted, the film 20 is shorter than the distance separating its fixing points. When it is being installed, the film 20 is fixed to a first of the two elements and is then deformed in its elastic domain to reach its fixing line on the second of the two elements. When the torso 2 pivots to one side, over a first part of the angular displacement, the film 20 can remain under tension on either side of the joint 13. Subsequently, when the torso 2 tilts beyond this first part of the displacement, the film 20 can relax completely and thus form the fold 23. However, it is preferable to avoid the fold 23 being excessive. It is even desirable to completely avoid the risk of a fold forming. To this end, the film 20 is preloaded so as to maintain tension over the entire range of angular displacement.

The film 20 can be made of elastic material, for example rubber or silicone. The film 20 can be made of fibers that can be distributed uniformly. Alternatively, the film 20 can be made of fabric. Weaving has the advantage of allowing different characteristics along the directions of the surface of the film 20. It is thus possible to provide maximum elongations and modules of elasticity that are different depending on the direction of the fibers. Elastane is known for its elasticity and can be employed in a fabric forming the film 20. Elastane is made for example from a polyether-polyurea copolymer.

The film 20 is kept at a distance from the internal components of the joint. The film 20 thus limits access to these components by elements exterior to the robot. The film 20 thus helps to protect the robot with respect to its environment and to protect the environment itself from a mechanical, thermal and even electrical point of view. As regards the thermal aspect, the film 20 can be breathable and allow air to pass through, thereby favoring exchanges of heat between the robot and its environment so as to make it easier to cool. The film 20 can also form a heat shield that thus protects the robot with respect to external heat sources liable to damage the joint. As regards the electrical aspect, the film 20 can be made of an insulating material, protecting both the robot and its environment from risks associated with contact with high electric potentials. Alternatively or in addition, the film 20 may comprise a layer or conductive fibers for creating an electrostatic or electromagnetic shield.

In order to limit the formation of folds when the torso 2 tilts, the robot 15 advantageously comprises a collar 24 surrounding one of the elements connected by the joint 13, for example the pelvis 8. The collar 24 is connected to the pelvis 8 by way of a pivot link 25. The film 20 is fixed to the pelvis 8 by way of the collar 24. In other words, the film 20 is fixed to the collar 24. As before, the film 20 can be fixed to the collar 24 in a continuous or discontinuous manner.

The pivot link 25 is free. In other words, the pivot link 25 is not motorized. During the tilting of the torso 2 with respect to the pelvis 8 about the axis X, the film 20 drives the collar 24 in rotation with respect to the pelvis 8. The driving is brought about by the stretched side of the film 20, which pulls the collar 24. By contrast, the relaxed side of the film 20 does not retain the collar 24, or retains it less. The rotation of the collar 24 thus limits the formation of folds on the relaxed side of the film 20 when the torso 2 tilts about an axis parallel to that of the pivot link 25. Advantageously, the axis of the pivot link 25 and the axis X are coincident, in order to obtain tension in the film 20 that is regularly distributed when the film 20 drives the collar 24.

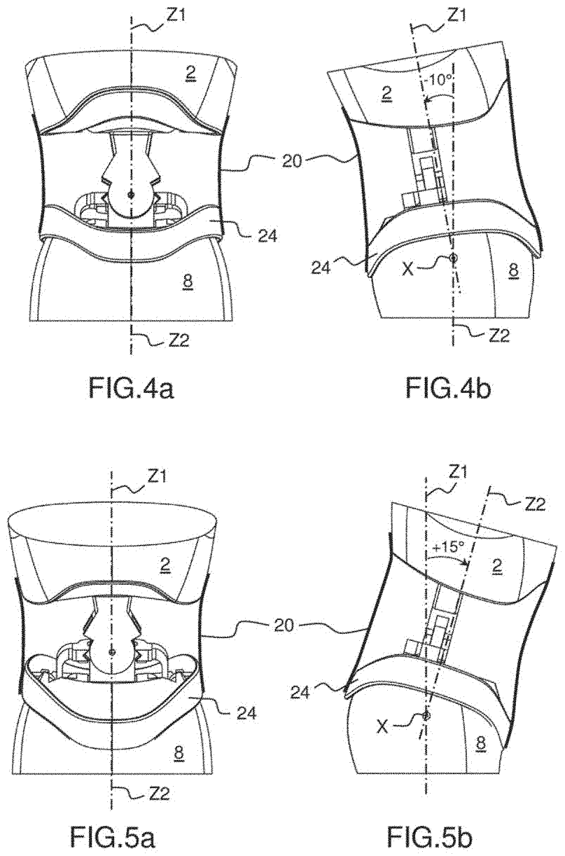

FIGS. 4a and 4b, for the one part, and 5a and 5b, for the other part, show two tilted configurations of the torso 2, in which the collar 24 is driven by the film 20. In the configuration in FIGS. 4a and 4b, the torso 2 of the robot pivots through 10° toward the rear. By convention, the rotation takes place through −10° about the axis X. The collar 24 also pivots through −10° about the axis X. In the configuration in FIGS. 5a and 5b, the torso 2 of the robot 15 pivots through 15° toward the front. By convention, the rotation takes place through +15° about the axis X. The collar 24 also pivots through +15° about the axis X. In these two configurations, the film 20 maintains the shape it has in the vertical configuration shown in FIGS. 2a and 2b since the collar 24 tilts at the same angle as the torso 2. More generally, this maintained shape of the film 20 remains identical for the entire tilting of the torso 2 through −10° to +15° about the axis X.

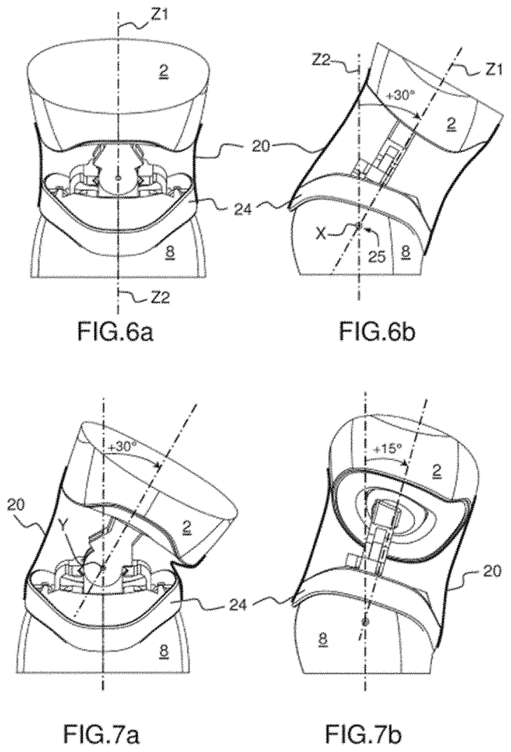

The maximum angular displacement of the torso 2 about the axis X is greater than that of the collar 24. The angular displacement of the collar 24 is, in the example shown, limited to −10° and to +15° about the axis X. By contrast, the torso 2 can tilt toward the front through more than +15° about the axis X. The collar 24 is not obligatory. However, it has the advantage of increasing the angular displacement of the torso 2 before a fold is formed in the film 20. FIGS. 6a and 6b show the torso 2 and the pelvis 8 of the robot 15 in a configuration in which the torso 2 of the robot pivots through 30° toward the front. The collar 24 is in abutment and only pivots through +15° about the axis X. The presence of a pivoting collar 24 allows the film 20 to maintain a form limiting the occurrence of folds on the relaxed side while allowing a large angular displacement of the torso 2 with respect to the pelvis 8.

It is of course possible to combine the rotations about the two axes X and Y. FIGS. 7a and 7b show the torso 2 and the pelvis 8 of the robot 15 in a configuration in which the torso 2 of the robot pivots through +15° about the axis X and through +30° about the axis Y. The collar 24 also pivots through +15° about the axis X.

Another disposition of the robot 15 is advantageously implemented to limit the formation of folds. This disposition can be implemented instead of or in addition to the collar 24. More specifically, in the example shown, for the rotation about the axis X in the vertical configuration in which the axes Z1 and Z2 are aligned, as shown in FIGS. 2a and 2b, the film 20 takes up an angular sector ax about the axis X between its two fixing points, one to the torso 2 and the other to the pelvis 8. Similarly, the film 20 takes up an angular sector α_{Y} about the axis Y between its two fixing points. When the film 20 relaxes, the angular sector ax becomes smaller and the reduction in length of the film 20 between its two fixing points changes initially in proportion to the reduction in size of the angular sector or to the sine thereof. The same goes for an extension of the film 20. Consequently, the larger the desired angular range of rotation about a rest configuration, the larger the angular sector taken up by the film 20 in its rest position has to be in order to control a ratio between the elongation of the length of the film 20 and its actual length.

In the example shown, the angular displacement about a vertical position in which the axes Z1 and Z2 are aligned is greater about the axis X toward the front: from 0° to 45°, than on the side about the axis Y: 15° on either side of the vertical position. In order to control the elongation or reduction in length of the film 20, an angular sector about the axis X that is taken up by the film 20 between its fixing points is greater than an angular sector about the axis Y that is taken up by the film 20 between its fixing points. At rest, in the configuration shown in FIGS. 2a and 2b, the angular sector α_{Y} is 45° and the angular sector ax is 53°. This characteristic brings about a skewed shape of the lines on which the fixing points of the film 20 are positioned, on the torso 2 on one side and on the collar 24 on the other.

1. A robot comprising:
two elements that are movable with respect to one another,
a joint having at least one degree of freedom connecting the two elements,
a flexible and elastic film that surrounds the joint and is fixed to each of the two elements, the film being stretched between a first fixing point on the first element and a second fixing point on the second element in at least one configuration of the two elements, the tension in the film varying depending on a variation in a distance between the two fixing points during movements of the joint about the configuration, and
a collar that surrounds a first of the two elements and is connected to the first element by way of a free pivot link, wherein the film is fixed to the first element by way of the collar.

2. The robot as claimed in claim 1, wherein the tension in the film is substantially proportional to the variation in the distance.

3. (canceled)

4. The robot as claimed in claim 1, wherein the joint is rotatable about a first axis, and wherein an axis of rotation of the pivot link connecting the collar to the first element is coincident with the first axis.

5. The robot as claimed in claim 4, wherein a range of angular displacement of the joint about the first axis is greater than a range of angular displacement of the pivot link about the first axis.

6. The robot as claimed in claim 1, wherein the joint is rotatable about a first axis and about a second axis perpendicular to the first axis, wherein an angular displacement of the joint about the first axis is greater than an angular displacement of the joint about the second axis, and wherein an angular sector about the first axis that is taken up by the film between its fixing points is greater than an angular sector about the second axis that is taken up by the film between its fixing points.

7. The robot as claimed in claim 1, wherein the film is preloaded so as to maintain tension on either side of the joint over at least a part of a range of angular displacement of the joint.

8. The robot as claimed in claim 1, wherein the film is a fabric.

9. The robot as claimed in claim 8, wherein the fabric comprises a fiber based on a polyether-polyurea copolymer.

10. The robot as claimed in claim 8, wherein the fabric is breathable.

11. The robot as claimed in claim 1, wherein the film comprises an electrically insulating material.

12. The robot as claimed in claim 1, wherein the film comprises an electrically conducting material.

13. The robot as claimed in claim 1, wherein the robot is a humanoid robot and comprises a torso and a pelvis, the joint connecting the torso and the pelvis.
